(19) United States
(12) Patent Application Publication
(10) Pub. No.: US 2005/0262119 A1
(43) Pub. Date: Nov. 24, 2005

(54) Data processing systems and methods

(76) Inventor: Gary Mawdsley, Carnforth (GB)

Correspondence Address: GARY MAWDSLEY, GARDEN COTTAGE, CASTERTON, CARNFORTH, LA6 2RZ, GB

(21) Appl. No.: 11/134,441

(22) Filed: May 23, 2005

Related U.S. Application Data
(60) Provisional application No. 60/577,915, filed on Jun. 9, 2004.

(30) Foreign Application Priority Data
May 24, 2004 (GB) 0411535.8

(51) Int. Cl. G06F 7/00

(52) U.S. Cl. 707/100

(57) ABSTRACT

This invention generally relates to data processing systems and methods, more particularly to computer systems and related methods for defining unified work flow processors which rely on data and/or services provided by a plurality of disparate underlying systems. A method of constructing a data processing operation, the data processing operation utilising data and/or services provided by a plurality of existing underlying systems, the method comprising: constructing a set of superobjects, a said superobject comprising an aggregation of data and/or services made available by said underlying systems and providing a common interface to said systems; and assembling a plurality of said superobjects to define a workflow for said data processing operation, said workflow comprising a group of linked superobjects defining a processing sequence for the superobjects of said group, to thereby construct said operation.

### FIELD OF THE INVENTION

This invention generally relates to data processing systems and methods, more particularly to computer systems and related methods for defining unified workflow processes which rely on data and/or services provided by a plurality of disparate underlying systems.

### BACKGROUND TO THE INVENTION

Large companies and organisations, as they evolve, tend to implement a number of substantially separate computer systems to perform particular tasks. In the case of a company these may comprise tasks such as customer relationship management (CRM), company accounting, company document management and the like; in an institution such as the British National Health Service (NHS) these may comprise tasks such as managing patient records and storing clinical data, for example from diagnostic imaging or pathological tissue examination, as well as finance and document management. In a large organisation there may be a large number of such computer systems and in some instances data may be duplicated between different systems so that, for example, records relating to a particular customer may appear in both a CRM database and an accounting database, although this may not be obvious as data/service labelling and formats will in general be different.

A major problem in such organisations is how to integrate data from these disparate existing systems which, in general, must be accessed separately. This problem is compounded as these existing systems become more complex, for example providing services as well as data. In this context a service may be considered as a procedure which, normally, accepts some input data, performs one or more operations on this data, and provides resulting output data.

In the past the main approach to dealing with data from disparate sources has involved collecting data from all the sources into a single large database or data warehouse; this normally also requires some data cleaning and merging operations. This is a very expensive and time-consuming procedure and such projects are apt to overrun, and often results are less than successful. Moreover this approach does not lend itself to the management of services provided by existing computer systems, and nor does it facilitate two-way processes which involve writing data back into one or more existing computer systems. For certain specific application areas more sophisticated technologies have been developed, for example GenieBuilder (trademark) from VoiceGenie, and IBM WebSphere (trademark) for developing e-business solutions, but these prior art technologies lack general applicability and are still relatively complex to implement. Further background art can be found in U.S. 2002/0194181, U.S. 2003/0120711, U.S. 2003/0120600, U.S. Pat. No. 6,012,067, U.S. Pat. No. 6,640,231, and Xavier, E, “Using Extensible Query Language (XQL) for Database Applications”, 17-20 Apr. 2001, IEEE.

### SUMMARY OF THE INVENTION

According to a first aspect of the present invention there is therefore provided a method of constructing a data processing operation, the data processing operation utilising data and/or services provided by a plurality of existing underlying systems, the method comprising: constructing a set of superobjects, a said superobject comprising an aggregation of data and/or services made available by said underlying systems and providing a common interface to said systems; and assembling a plurality of said superobjects to define a workflow for said data processing operation, said workflow comprising a group of linked superobjects defining a processing sequence for the superobjects of said group, to thereby construct said operation.

In embodiments creating a set of superobjects expressed as an aggregation of resources, such as data and/or services in particular web services, providing a common interface to the underlying systems, facilitates a very straightforward drag-and-drop graphical user interface to the construction of a user-definable process for an enterprise workflow. To illustrate the simplicity with which large complex databases may be queried, in one embodiment as untrained user with a mobile phone is able to create a process to retrieve relevant football results. In another example an NHS nurse is able to construct a process to retrieve patient information from a plurality of underlying systems storing complex and sometimes overlapping data.

A workflow typically comprises a set of data inputs and outputs and the coordinated execution of tasks performed by workflow resources derived from the existing underlying systems. The superobjects may therefore comprise data objects and/or service objects to provide a resource such as data processing task or service, or an integrated combination of data and one or more processes. The superobjects are preferably assembled in accordance with data input for example from a user interface, defining a connected configuration of the superobjects. Likewise the superobjects are preferably constructed in accordance with user input data, although in some embodiments a preconstructed set of superobjects may be employed and the superobject constructing dispensed with.

The existing underlying systems are generally substantially separate, although there may be some overlap as mentioned in the introduction, and these provide real resources; a superobject may also incorporate resources made available over the Internet. The existing systems may include any conventional computer system providing resources and embodiments of the invention are particularly useful in conjunction with large, business-wide databases, for example CRM systems such as KANA (trademark) or HEAT (trademark). As well as data such systems typically provide a range of services which are aggregated, as described in more detail later, to provide super enterprise services. These may be represented as single graphical units and then manipulated in a very straightforward and intuitive manner on a platform requiring relatively little computing power. For example code to implement embodiments of the above described method can run in memory. Thus with the above described approach it is simple and quick to construct workflow procedures which interact in a complex manner with a number of large-scale enterprise data processing systems substantially transparently to a user.

In a related aspect of the present invention there is provided a method of constructing a data processing operation comprising a query, the data processing operation utilising data and/or services provided by a plurality of existing underlying systems, the method comprising: constructing a set of superobjects, a said superobject comprising an aggregation of data and/or services made available by said underlying systems and providing a common interface to said systems; and constructing a said query to act on said set of superobjects to thereby query information from two or more of said underlying systems.

The skilled person will understand that there is a problem with attempting to form a query across two or more existing, generally separate computer systems as each system will have its own database engine specific to the system. However by aggregating data from two or more existing systems in a set of one or more superobjects, in preferred embodiments stored in memory, one can construct a query, for example in a conventional database query language such as SQL, to act on the set of superobjects and thus span information in two or more databases. Implementing a superobject level of data also facilitates recording and/or controlling access to data and/or services in one or more of the underlying systems. This is because this can be performed at superobject level, in particular at an interface to a superobject upon which, say, a query operates, rather than adding audit trail logging separately into a database engine of each underlying system.

By way of example there may be stored in memory an array of customer superobjects comprising aggregated data from a CRM system and a customer correspondence tracking system. The question may then be posed: “Are there customers in Cumbria with whom we have corresponded by email within the last week?”. In another example NHS blood test results are stored in two or more different repositories and a query may straightforwardly be implemented across the different repositories, with a common access control/auditing system.

In preferred embodiments of the above methods a superobject interfaces using a markup language, in particular XML (extensible markup language) such as XML version 1.0. In this way superservices can be configured to appear to a graphical workflow procedure defining engine as web services, a process of merging and/or translation within a superobject hiding the complexity of the underlying structure. This further facilitates querying of the superobjects, for example by providing a query module operating on superobject metadata to locate desired web services, for example using an XML schema to define requirements for such a service. This structure also facilitates the implementation of rules to control and/or audit access, in particular for data at or above the enterprise data or superobject level. This facilitates control of access to the underlying systems where a particular role or user may be allowed access to portions of some or all the systems but not to other portions, the particular portions of data/services to which access is permitted being dependent upon user permissions.

In preferred embodiments the superobjects include a data read superobject, a process superobject, and a data output superobject. The data output superobject is preferably configured for writing data back to one or more of the underlying systems in a coherent manner. Thus, for example, where the same data appears in two or more systems, albeit perhaps under different names, a superobject can be configured to update both systems as necessary. Likewise duplication of data can be avoided by selecting and/or merging data from two or more systems in a superobject even when the systems themselves do not include explicit links between the same data in the different systems.

As previously mentioned, assembling the superobjects to define a workflow is preferably carried out using a graphical user interface to select the superobjects and define one or more ordered interconnections between the objects. In this way a complex procedure can be represented by a simple graphical structure and a process employing resources from a plurality of the existing systems may be represented by a single icon in the graphical user interface, rather than by a plurality of separate icons one for each resource (data/service) associated with an underlying system. In preferred embodiments a graphical depiction of a defined workflow data processing operation comprises a series of icons and connecting links, preferably different icons being employed for enterprise data superobjects and enterprise service superobjects. The workflow data processing operation may include branches; where an XML schema is employed, for example, a branch selected by the data processing operation may depend upon a data subtype.

Thus in preferred embodiments of the method at least one superobject has a plurality of states and associated state identification data, which may be formatted as an XML data subtype having a plurality of switches. For example, for a service superobject there may be a plurality of states of the superobject that returned from the service; and for a data superobject the state of the superobject may depend upon the data retrieved. Preferably a plurality of links is provided between the at least superobject having a plurality of states and other superobjects; advantageously where such a superobject is represented in a graphical user interface by an icon one link may be provided for each state of the superobject, that is for example for each subtype into which it falls. This facilitates the creation of complex data processing operations without programming in a conventional sense. To facilitate construction of a data processing operation or work flow superobjects for data or services may be given easily recognisable icons such as a telephone, document and the like, that is related to the data/service with which they are associated.

A graphical approach such as that described above need not employ a programming script in order to implement a logical operation. For example in a data type “invoice” with associated invoice amount data one can derive, say, a first subtype for a low invoice value (say amount less than £1,000) and a second type for high invoice value (say amount greater than £1,000) and provide two links for the icon in the graphical user interface. Then, in this example, a user can select either or both of the outputs to define a subsequent interaction to, in effect, achieve a branch operation. It will be appreciated that more complex logical operations may also be handled in a similar manner in order to incorporate logical operations in a data flow defined by the data processing operation or work flow.

The invention also provides a data structure defining a data processing operation comprising a query, the data processing operation utilising data and/or services provided by a plurality of existing underlying systems, the data structure comprising: a set of superobjects, a said superobject comprising an aggregation of data and/or services made available by said underlying systems and providing a common inderface to said systems; and data defining a said query to act on said set of superobjects to thereby query information from two or more of said underlying systems.

The invention further provides a method of opportunistic monitoring of information on the Internet, the method comprising: scheduling a data processing operation for automatic implementation; and running said data processing operation to retrieve and monitor information on the Internet.

Thus in embodiments data defining a data processing operation may reside on, say, a server and be scheduled to run at intervals (and/or under user control) in order to opportunistically monitor the Internet, in particular the World Wide Web, for data previously defined as in category of interest (for example, to a user). Thus, for example, a data processing operation may be created to check Google (Trade Mark) every three days for auctions for bicycles costing <£100; or other more complex opportunistic monitoring queries may be defined.

Thus the invention also provides a data structure defining a data processing operation, the data processing operation utilising data and/or services provided by a plurality of existing underlying systems, the data structure comprising: a set of superobjects, a said superobject comprising an aggregation of data and/or services made available by said underlying systems and providing a common interface to said systems; and data defining a workflow for said data processing operation, said workflow comprising a group of linked superobjects defining a processing sequence for the superobjects of said group, to thereby define said operation.

As mentioned above where substantially the same data and/or service is provided by two or more existing systems, which may or may not be partially interlinked, preferably a superobject is configured to translate to a common representation for this data/service. This common representation may be a representation employed by one or other of the existing systems or it may be a new representation.

Thus in another aspect the invention provides a data structure defining a computer data processing object, the object having: a plurality of first interfaces, each said first interface comprising a first markup language schema for interfacing to an existing data storage and/or processing system; and a second interface for providing a common interface to said existing data processing systems.

Preferably the first and second interfaces both comprise a markup language, in particular an XML schema, and preferably the data structure includes code to translate data from a schema of the first interface to a schema of the second interface. The first interfaces may comprise interfaces to a plurality of web services and the second interface may then provide a combination or aggregation of these web services as a single web service. The data structure may further be configured to map a common data (or service) item at one or more of the first interfaces to a single, unified data item (or service) at the second interface; at this second interface the common data item (or service) may appear in a different form than its definition at the first interfaces. This mapping may be operable for data flow in a single direction, for example from the first interfaces to the second interface, or for data flows in both directions between the first interfaces and the second interface (i.e. reading and writing).

Thus in a related aspect the invention further provides a method of providing a unified interface to a plurality of existing data storage and/or processing systems, the method comprising: interfacing to said plurality of existing storage and/or processing systems using a corresponding plurality of first markup language interfaces; and translating data and/or services made available by said plurality of existing systems to a single, common second interface using a second markup language.

The invention also provides data processing code, in particular on a carrier, to implement this method.

In another aspect the invention provides a computer system for constructing a data processing operation, the computer system comprising: data memory operable to store a data structure corresponding to said data processing operation; program memory storing computer program code; and a processor coupled to said data memory and to said program memory to load and implement said code, said code comprising code to, when running: construct a set of superobjects, a said superobject comprising an aggregation of data and/or services made available by said underlying systems and providing a common interface to said systems; assemble a plurality of said superobjects to define a workflow for said data processing operation, said workflow comprising a group of linked superobjects defining a processing sequence for the superobjects of said group to thereby define said data structure; and/or construct a query to act on said set of superobjects to thereby query information from two or more of said underlying systems.

In a further aspect the invention provides a business application development platform having a graphical user interface (GUI), said interface comprising: a viewing module configured to allow a user to view a set of operations available on a plurality of existing computer systems; a business application development module configured to allow said user to graphically select and place said operations into said business application; and an output module to output said business application as one or more markup language documents.

The operations may comprise operations available on separate computer systems, for example web services provided by separate computers within an organisation and/or external web services, for example available via the Internet. The business application development module preferably provides a drag-and-drop graphical user interface to place the operations in an interconnected and normally ordered configuration to define the business application. The output module preferably outputs the application as a set of XML documents.

In preferred embodiments the business application development platform (which may be implemented in conventional programming code on a computer system) automatically handles the creation of data/service translation templates and thus enables the use of a high level graphical interface to perform the main functions of importing data objects and setting up data transfer gateways between separate systems to form full business applications as sets of XML pages. Thus preferably the platform further comprises a translation module configured to create a translation template for translating between data and/or service provided by one of the existing computer systems and an internal interface schema used by the business application for interconnecting the operations. The translation module may be manual, semi-automatic or fully automatic, although a semi-automatic system with some manual review/correction of the translation is often preferable. Where two or more of the existing computer systems provide substantially the same data/service in different formats the translation module may be configured for resolving these to a single common format, preferably comprising a markup language, in particular XML, schema. Preferably the business application development module is also configured to define a plurality of data transfer gateways between the existing computer systems.

The above described methods, systems and data structures may be implemented in data processor control code in any conventional language. This code may be provided on a data carrier such as a disk, CD- or DVD-ROM, programmed memory such as read only memory (firmware), or on a data carrier such as an optical or electrical signal carrier. As the skilled person will appreciate code and/or data may be distributed between a plurality of coupled components in communication with one another, for example on a network.

### BRIEF DESCRIPTION OF THE DRAWINGS

These and other aspects of the present invention will now be further described, by way of example only, with reference to the accompanying figures in which:

FIG. 1 shows an example of a system for constructing a data processing operation using superobjects, according to an embodiment of an aspect of the present invention;

FIG. 2 shows a schematic diagram of translation within a superobject from a plurality of services to a single, common schema, according to an embodiment of an aspect of the present invention;

FIG. 3 shows a flow diagram of a procedure for determining normalised superobject data elements;

FIG. 4 shows a flow diagram of a procedure for a semantic mediation scheme;

FIG. 5 shows a flow diagram of a procedure for a graphical user interface with drag and drop components;

FIG. 6 shows an example of a physical system implementing an embodiment of an aspect of the present invention; and

FIG. 7 shows components of a workflow process.

### DETAILED DESCRIPTION OF THE PREFERRED EMBODIMENTS

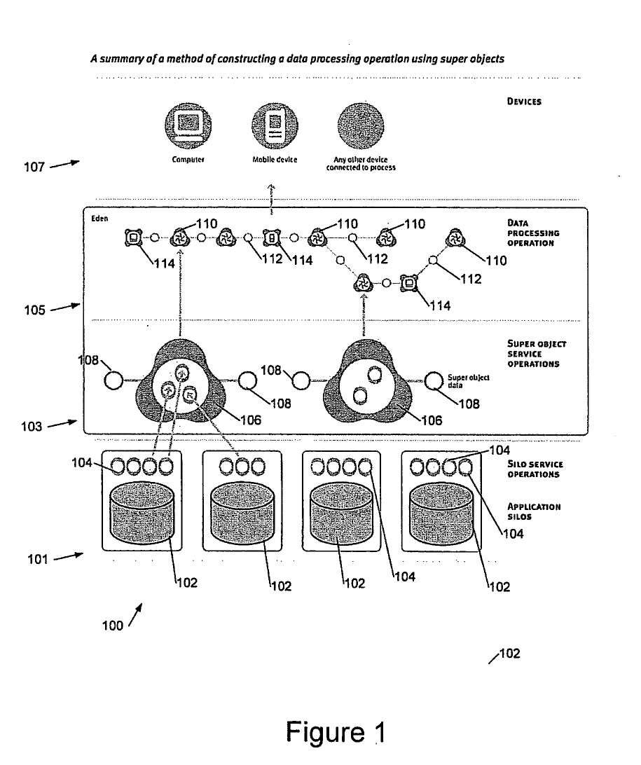

Referring to FIG. 1, this shows an overview of a system 100 for constructing a data processing operation using superobjects.

Working from the bottom, layer 101 shows a number of underlying computer applications; they are here called “application silos” and are represented by the (grey) cylinders 102. Some examples of a computer application are: a bespoke application developed in-house by an organisation; a packaged solution from an application vendor; an Internet application; a web site. Each silo 102 is shown with an array of service operations, shown as small (orange) ovals 104. The service operations represent an application programming interface (API) to the underlying application silo. They act as the “gateway” to the application silo logic. Examples of service operations are: web services; proprietary components like Microsoft COM components and Sun Enterprise Java beans; adapter components used in Enterprise Application Integrations (EAI) tools like TIBCO's Rendez-Vous.

The next layer 103 shows superobject operations. The superobject operations represent an abstraction of related pieces of logic from the underlying application silos. A superobject operation comprises a definition which is embodied in data as described later. For example, within the arena of Local Government child care, information relating to a child maybe stored across a number of application silos: the first stores basic details like name, address and data of birth; the second a children at risk register detailing concerns; and the third an education assessment application. A superobject operation named “Get Child Details” may be defined in terms of retrieval operations on the underlying silos. This superobject definition may then be used to effect the retrieval of all the child's details from the underlying silos to present a unified view of the child. Conversely, a second example is the updating of child data via one superobject operation named “Save Child Details” that is defined in terms of real silo services that save the relevant part of the unified view of the child's data.

A larger (orange) shape 106 represents a superobject service operation and the (grey) circles 108 represent input and output placeholders; input on the right hand side and output on the left. The placeholders represent superobject data. In the example above the input placeholder represents a union of child selection criteria across the silos and the output placeholder represents a unified view of the child data.

Moving up to layer 105; the network in the diagram represents an enterprise process map. This is a data processing operation that aggregates logic from one or more application silos. It achieves this by allowing data processing operations to be expressed in terms of superobject operations (and hence superobject data). The curved triangular shapes 110 containing “turbines” at their centre represent a superobject operation, the (grey) circles 112 represent superobject data flows. The other shapes 114 represent interactions with an outside body; for example, a person or a device.

Interaction is employed to display the results of a data processing operation or solicit information in order that a data processing operation can proceed further.

The upmost layer 107 represents devices used to interact with the outside world.

From this overview example we will consider the following:—

Detailed example definition of a superobject and how it is formed.

Consideration of a high level graphical user interface with drag and drop components necessary for the simple creation of a powerful data processing operation.

A example physical system configuration.

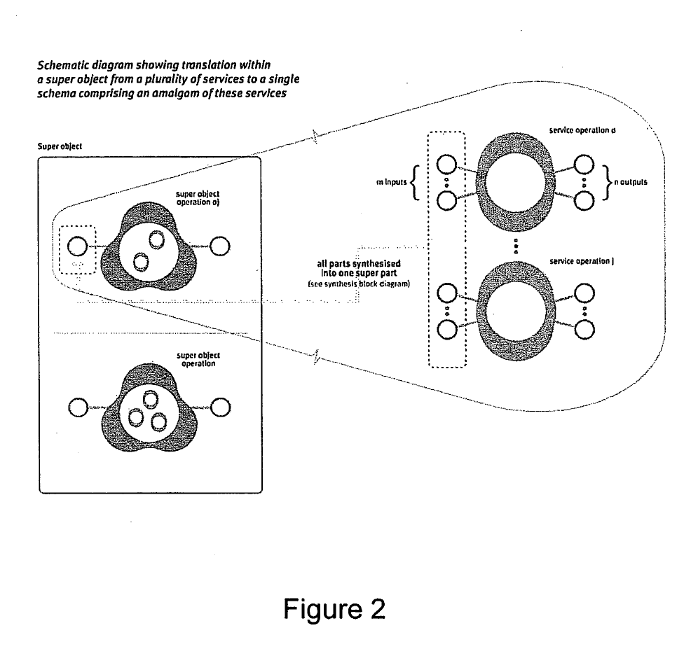

Referring now to FIG. 2, this shows a schematic diagram of translation within a superobject from a plurality of services to a single schema comprising an amalgam of these services.

A superobject comprises a set of superobject operations and a virtual data schema that summarises a data domain of the underlying application silo services used in the superobject service operation construction.

The right hand side of the diagram in FIG. 2 shows an array of silo level service operations that are used to define a superobject operation. Each silo service operation is shown to have multiple input data elements and multiple output data elements. This is a general case. The superobject operation definition is formed by:—

Recording a list of underlying silo service operations that comprise the superobject operation

Combining all of the silo level service operation input data elements in a single normalised data element, which we call the superobject input data element. This is represented in the diagram using a dotted line around the silo service operation inputs and a dotted line around the superobject data input element.

Combining all of the silo level service operation output data elements in a single normalised data element, which we call the superobject output data element.

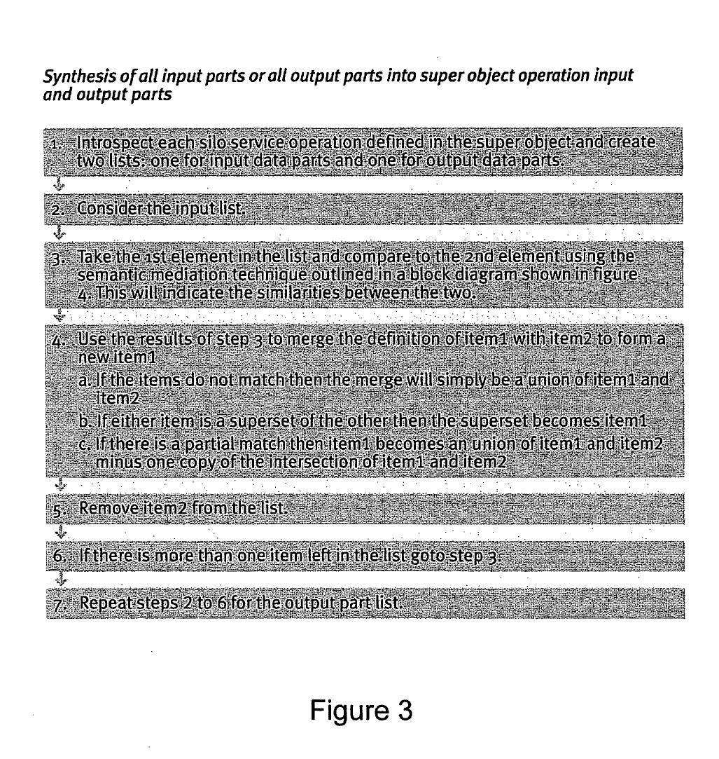

FIG. 3 details the steps used to determine normalised superobject data elements for both input and output.

Thus in particular this shows synthesis of all input parts or all output parts into super object operation input and output parts.

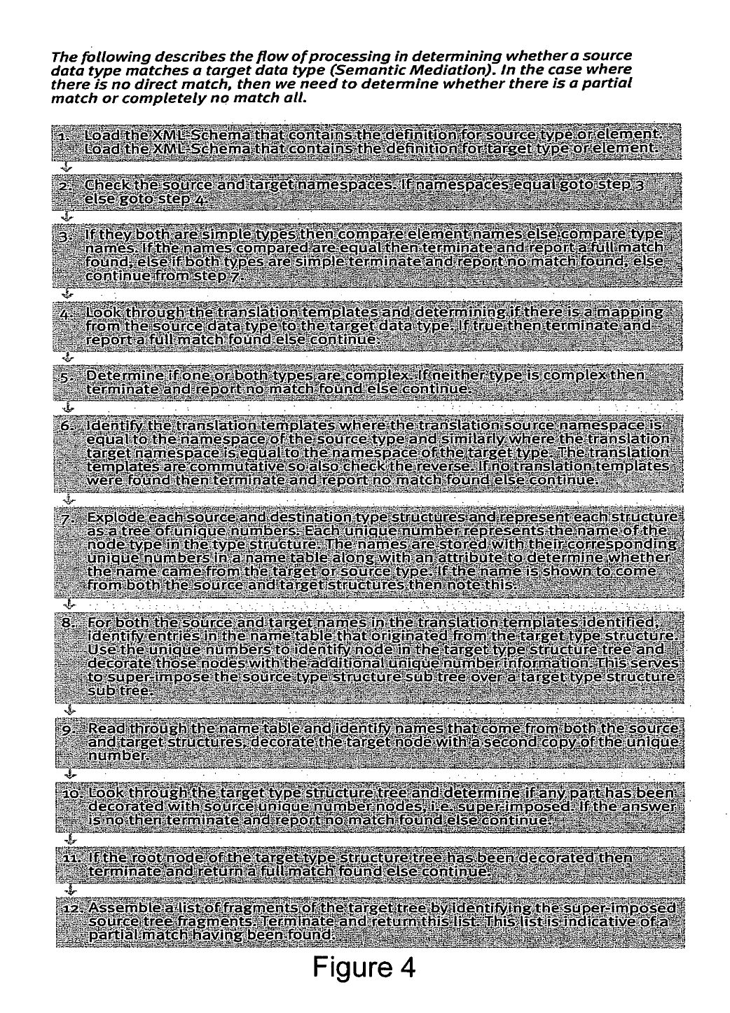

FIG. 4 details the steps used in determining a (precise) relationship between one data item and another. In this example the schemas describing the data are XMLSchemas.

In particular FIG. 4 describes the flow of processing in determining whether a source data type matches a target data type (Semantic Mediation). In the case where there is no direct match, then we need to determine whether there is a partial match or completely no match all.

Thus FIG. 4 describes a semantic mediation scheme where two data elements or data types are compared in order to determine whether they match in a way, entirely or partially or not at all. In this example it is assumed that both the source and target elements are from data domains defined using XMLSchema. This will be the case for example when the underlying silo service operations are web service operations.

XmlSchema uses the notion of namespaces to constrain and identify the data domain. A namespace name should be unique. An element or type name may then be made unique when considered within the context of a namespace. The mediation process described in FIG. 4 takes into account the namespace name. Similarly translation template entries are preferably always expressed in terms namespacei:typenamej is equivalent to namespacez:typenamex.

Example Data Structure of a Super Object

<?xml version=“1.0”?>
<rdf:RDF
xmlns:rdf=“http://www.w3.org/1999/02/22-ref-syntax-ns#”
xmlns:esap=“urn:orangery-com:esa-plafform”>
<rdf:Description rdf:about=“enterprise-service-name”>

<esap:Schema rdf:resource=“Schema” />
<esap:EnterpriseServiceOperation rdf:resource=“enterprise-
service-operation_name#i” />
<esap:EnterpriseServiceOperatlon rdf:resource=“enterprise-
service-operation_name#j” />

<rdf:Description>
<rdf:Description rdf:about=“enterprise-service-operation_name#i”>

<esap:OperationName>enterprise-service-operation_name#i</
esap:OperationName>
<esap:SiloServiceOperation rdf:resource=“silo-service-guid#a” />
<esap:SiloServiceOperation rdf:resource=“silo-service-guld#b” />

</rdf:Description>
<rdf:Description rdf:about=“silo-service-guid#a”>

<esap:OperationName>silo-service-operation-
name#a</esap:OperationName>

</rdf:Description>
(rdf:Description rdf:about=“silo-service-guid#b”>

<esap:OperationName>silo-service-operation-
name#b</esap:OperationName>

</rdf:Description>
<rdf:Description rdf:about=“Schema”>

<xsd:schema targetNamespace=“urn:orangery-com:esa-platform”

xmlns:xsd=“http://www.w3.org/2001/XMLSchema”
xmlns=“urn:orangery-com:esa-platform”>

<xsd:complexType name=“enterprise-service-
operation-name-input-type”>

<xsd:all>

<!-- in here appears data types from the silo service schemas that
represent the merging of all input data types-->

</xsd:all>

</xsd:complexType>
<xsd:complexType name=“enterprise-service-
operation-name-output-type”>

<xsd:all>

<!-- in here appears data types from the silo service schemas that
represent the merging of all output data types-->

</xsd:all>

</xsd:complexType>
</xsd:schema>

</rdf:Descriptiotn>
</rdf:RDF>

The above example data structure shows the definition of a superobject as an XML serialisation of RDF. Resource Definition Framework (RDF) is a W3C controlled standard that details a mechanism for recording statements about resources so that machines can easily interpret the statements. It forms a basis to express relationships between resources and build knowledge. Here it is used to form a superobject definition in terms of the following resources:—
A number of silo service operations
A superobject schema derived by amalgamating schemas from the underlying silo service operation data inputs and output.

The input(s) for the superobject schema derivation are obtained from the semantic mediation technique described in FIG. 4. In this example the superobject schema is shown as an XMLSchema. In a domain example the superobject schema will make reference to the schemas of the underlying silo service operation data element definitions. The superobject schema is therefore a manifest of subsets of the silo application schemas.

The part beginning “enterprise-service-name” of the RDF definition defines the objects that comprise the definition: the schema; and in this case two superobject service operations. The strings “enterprise-service-operation-name#i” etc would normally contain the name of the operation.

The section beginning “enterprise-service-operation_namettic” describes a superobject service operation in terms of the underlying silo service operations. The silo services are referenced by unique identifiers called GUIDs. At runtime these GUIDs are translated to real service locations via databases that act as a central registry of services. This is known as binding and is useful since definitions can remain independent of implementation schemes.

The section beginning “silo-service-grid . . . ” is used to specify which operation(s) from the underlying silo service are to be used.

The section beginning “Schema” defines the virtual schema. In this example the schema would have a number of schema import statements within its heading. This is the XMLSchema mechanism to draw in existing schema definition. Part of the import statement comprises a network location describing where the referenced schema is to be found. This section shows new complex types being created to represent a single input and a single output data element. These complex types are expressed in terms of simple and complex types from the underlying (and imported) application silo data schemas.

This completes an example definition of a superobject and how it is formed. The next section considers an example high level user interface used to configure a data processing operation.

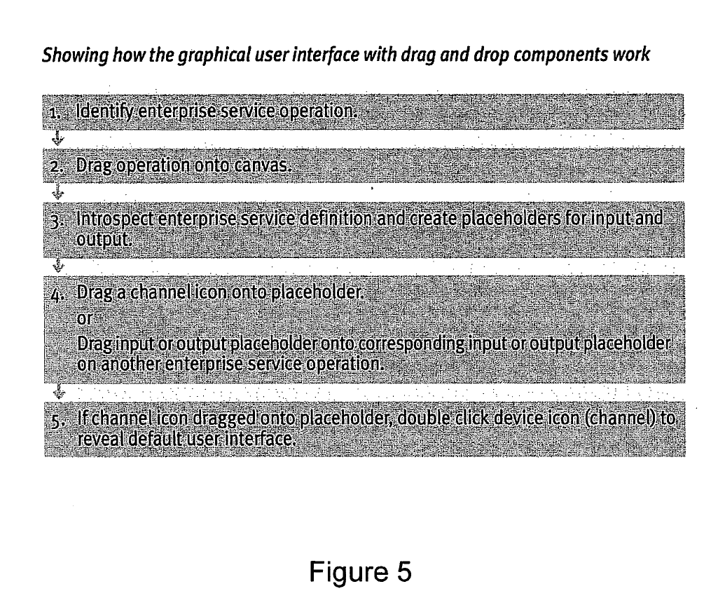

FIG. 5 details the steps used to create a data processing operation using high level graphical user interface tool.

In the implementation described here, the user starts with a blank drawing area for the creation of a data processing operation (or process map). The right hand side of the tool is used to display a list of superobjects (and their operations). The list of available superobjects is defined by inquiring upon standard databases of services. For example, with schemes like UDDI (discussed later), there are three global databases of services coordinated by the standards body OASIS and implemented by Microsoft, IBM and SAP. Using this tool superobjects can be filtered by data domains they “touch” making the identification of the appropriate service much easier.

Once the appropriate superobject service has been identified it can be dragged onto the canvas. In doing so, it will appear as a “turbine” icon seen in the penultimate layer of FIG. 1. It also has input and output placeholders describing any input or output data. In the case where data subtypes have been defined for a given superobject data type, then multiple placeholders will appear. Each placeholder represents a data subtype and this mechanism facilitates branching of flows. The placeholders can then be dragged onto other flows facilitating a network of superobject operations with superobject data flowing between one operation and the next. In the case where data needs to be solicited from the outside world and reported back to the outside world, icons representing external devices can be dragged onto the placeholders. Preferably these steps become special in that they support a mouse double click which leads into a screen design facility. The screen design facility preferably adapts itself to the appropriate screen dimensions of the targeted device, e.g. computer internet browser; mobile phone.

In a case where a placeholder is dragged onto a placeholder then the tool uses the semantic mediation technique described in FIG. 4 to determine the relationship between the data types represented by the two placeholders. If the target data requirement is satisfied entirely by the source, then the two turbines are joined directly. If not, then a new placeholder is drawn between the two; this represents the requirement for an external interaction in order to solicit information.

Placeholders can appear as icons instead of (for example grey) circles where an icon as been associated with a data type in advance. This serves to the make the user interface even more intuitive particular in the area of subtypes.

The resulting process map definition (data processing operation) is saved as a BPEL (Business Process Execution Language) map. This details the superobject(s) used and the flows connecting their operations. The map is preferably also defined in a scheme that allows it to be considered a service in its own right. The interaction with the outside world constitutes the exposed operations on the map itself.

The graphical user interface also allows for the following configuration capabilities:—defining a superobject; defining translation templates for use in semantic mediation; and assigning icons to well known data types.

Superobjects are defined by simply choosing the “new superobject” button in the tool bar. It can be given a name. The resulting definition is stored in a database (“Digital Asset Management System”). Superobject operations are added to the superobject by successively pressing the “Add Operation” button. Superobject operations are defined by first identifying the application silo service from a database of services, expanding it to reveal its operations and then simply dragging the operation onto the canvas, this is repeated for each silo service operation that's required in the superobject service operation definition. As a completed definition is saved then an entry is made in the services database for the new superobject.

The tool uses tree node association to allow for the specification of translation templates. Each namespace is represented as a nested tree of data types. The user simply drags one element from one tree onto the corresponding element in the next. The full XPATH of each node is recorded in an equivalence statement.

Any namespace can be view through the icon assembler graphical user interface as a tree structure. To assign an icon simply transverse down to the node in question and assign an image name and resource bundle. The image name must be the name of the resource in the resource bundle as stored in the Digital Asset Management System (DAMS).

This completes the section on the example high level graphical user interface. Finally we consider an example physical system configuration and example runtime operation.

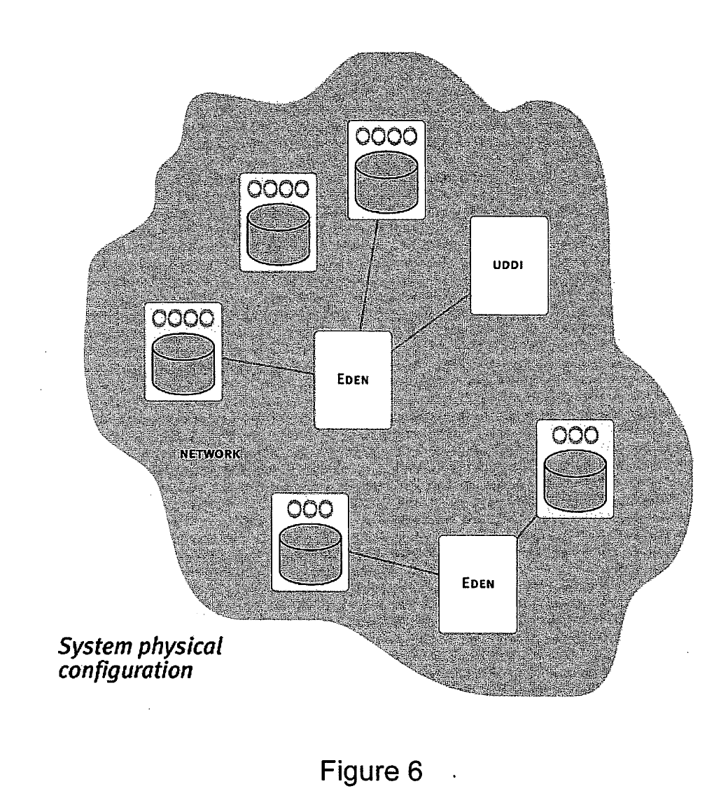

FIG. 6 shows an embodiment of the software (“Eden”) connected via a network to a number of application silos and an instance of a application silo operation lookup facility called UDDI.

FIG. 6 shows how Eden integrates with application silos at large. Eden is an example implementation of this invention. The network shown in the diagram can be of any type that connects people and devices, and, devices and devices. Example networks include Internet, IP Networks in general, Extranets, LANs, WANs, Wireless, biological.

The Universal Description, Discovery and Integration (UDDI) protocol is one of the major building blocks for successful Web services. UDDI creates a standard interoperable platform that enables companies and applications to quickly, easily, and dynamically find and use Web services over the Internet. UDDI also allows operational registries to be maintained for different purposes in different contexts. UDDI is an example of a mechanism by which silo services may be discovered and introspected.

During the authoring process Eden uses UDDI (via the network) to discover silo services (and their operations). It uses these definitions to facilitate the creation of superobjects (see above) via a high level graphical user interface. The superobjects are themselves published as services in service finder facilities such as UDDI. As described above, superobject service operations are then used to simply express powerful data processing operations. Those data processing operation definitions are registered as services in service finder facilities such as UDDI.

At runtime Eden brings to life the RDF based data processing operation definition and utilises the network to connect to (and invoke) the underlying silo service operations.

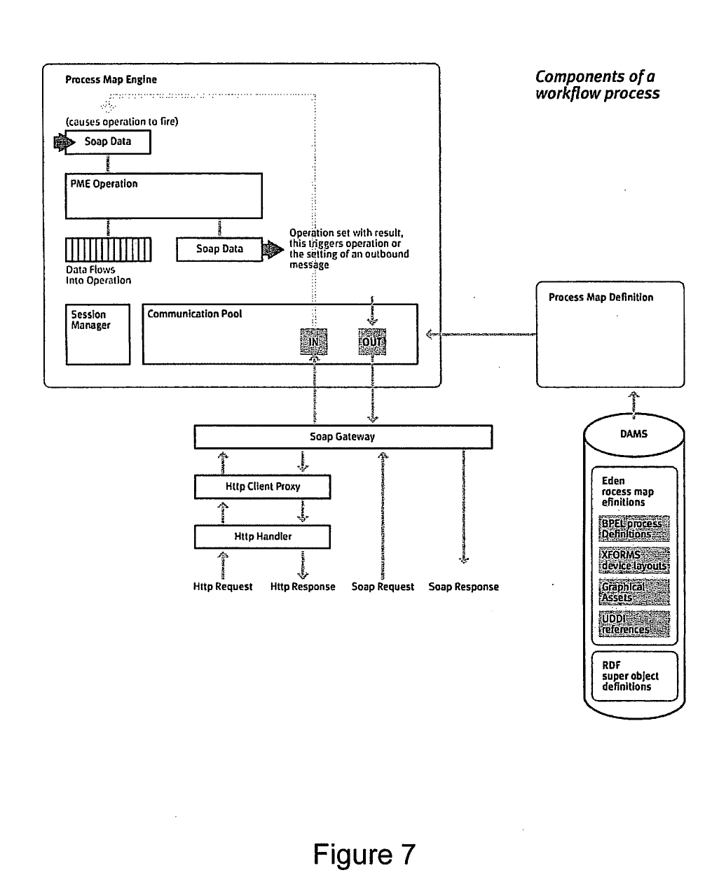

FIG. 7 details the example Eden runtime implementation of the invention. Within the figure there is a cylinder marked DAMS (Digital Asset Management System). This shows the components of a workflow process for the Eden example.

The data processing operation or process map is assembled using the graphical user interface described above and is expressed in terms of a flow of superobject data between superobjects. There are two levels of abstraction at work here; the first is that superobject definitions are stored in a DAMS but the flows within a map are expressed in terms of a GUID. The GUID is resolved in a real location using a service lookup data such as UDDI at runtime. The second is that the superobject definitions are expressed in terms of the GUIDs of the underlying application silo services.

A completed process map results in a structure with the following elements:—

A BPEL definition of the process flow. This is an OASIS standard for recording process flows.

A series of user interface layout definitions. They take the form of XFORMS.

XFORMS is a standard for specifying the layout of a user interface in a device neutral way.

An XML serialisation of the process flow picture, i.e. the one containing the turbines.

XSLT PARSE documents that allow non XML input data to be converted into XML adhering the superobject schema

Finally we consider the basic mechanics of the runtime environment for the data processing operation or process map. The key element used to set up the runtime for a process map is its BPEL definition of the process flow. Eden takes the BPEL definition and creates an object (PME Operation) inside the process map engine for every superobject operation defined in the map. It then takes the process flow information and wires together the PME Operations. Flows are wired by setting up a cascade of triggers from one PME Operation to the next. This is achieved using delegates and recording a list of flows into the operation. The list of inbound flows equates to a list of data elements required before the superobject operation can be fired. This represent the scenario where multiple superobject operation outputs are required to trigger a further superobject operation.

The communication pool acts as abstraction of the outside world. Data provided by the outside world become a message on the communication pool “IN” queue, and conversely data destined for the outside world resides on the communication pool “OUT” queue. After each operation completes, the setting of the output data field triggers (via the delegate) a check on the information flows. When the information flow is wired to an operation on the process map itself, the data is passed to the communication pool “OUT” queue. (As previously mentioned operations on the map represent interactions of the map with the outside world.)

When PME Operations are fired, the definition of the superobject is loaded and the RDF parsed to determine the locations of the real underlying silo services. Each defined real operation is successively executed and the resultant data aggregated in accordance with the rules of the superobject schema.

Further aspects of the invention are set out in the following clauses:

1. A method of constructing a data processing operation, the data processing operation utilising data and/or services provided by a plurality of existing underlying systems, the method comprising:
constructing a set of superobjects, a said superobject comprising an aggregation of data and/or services made available by said underlying systems and providing a common interface to said systems; and
assembling a plurality of said superobjects to define a workflow for said data processing operation, said workflow comprising a group of linked superobjects defining a processing sequence for the superobjects of said group, to thereby construct said operation.

2. A method as defined in clause 1 wherein at least one said superobject has a plurality of states, and associated state identification data, and wherein said assembling comprises creating a plurality of links between said at least one said superobject and one or more other superobjects, one link for each said state, or creating a selected link between said at least one said superobject and one or more other superobjects for a selected said state.

3. A method as defined in clause 2 wherein said state identification data is formatted as an XML data subtype having a plurality of switches to identify said plurality of states.

4. A method as defined in clause 1 wherein said assembling includes providing a graphical user interface for a user to select said superobjects and define said workflow.

5. A method as defined in clause 2 wherein said assembling includes providing a graphical user interface for a user to select said superobjects and define said workflow; and wherein said graphical user interface is configured to provide graphical icons for said superobjects, an icon for said at least one superobject with a plurality of states having a plurality of links, one for each said state.

6. A method as defined in clause 1 wherein said workflow includes reading data from one or more of said underlying systems, operating on said data using services of a plurality of said underlying systems defined by means of a single said superobject, and outputting a result.

7. A method as defined in clause 1 further comprising storing said set of superobjects in memory and performing said data processing operation on said stored superobjects.

8. A method as defined in clause 1 further comprising recording and/or controlling access to one or more of said underlying systems at the superobject level.

9. A method as defined in clause 1 wherein said data processing operation is embodied in a data structure, and wherein said constructing comprises defining said data structure.

10. A method as defined in clause 10 wherein said data structure comprises one or more markup language documents, or XML documents.

11. A method as defined in clause 1 wherein a said common interface comprises a markup language, or XML, schema.

12. A method as defined in clause 1 wherein a said superobject comprises a service superobject, wherein said aggregated services comprise web services, and wherein said common interface is configured as a web service resource.

13. A method as defined in 1 wherein said superobjects include at least a data read superobject, a process superobject, and a data output superobject.

14. A method as defined in clause 13 wherein said data output superobject is configured to write data back to one or more of said underlying systems.

15. A method as defined in clause 1 wherein substantially the same data and/or service is provided by two or more of said existing systems; and wherein a said superobject is configured to translate to a common representation for said data and/or service.

16. A method as defined in clause 15 wherein said common representation comprises a selection of said data and/or service from one of said existing systems.

17. A method as defined in clause 15 wherein a said superobject is configured to update substantially the same data and/or service in two or more of said existing systems for a data write operation.

18. A method as defined in clause 1 wherein said set of superobjects is stored in a data store, the method omitting said superobject set constructing.

19. A method as defined in clause 1 further comprising performing said data processing operation.

20. A carrier carrying computer program code to, when running, implement the method of clause 1.

21. A data processing system including the computer program code carrier of clause 20.

22. A method of constructing a data processing operation comprising a query, the data processing operation utilising data and/or services provided by a plurality of existing underlying systems, the method comprising:
constructing a set of superobjects, a said superobject comprising an aggregation of data and/or services made available by said underlying systems and providing a common interface to said systems; and
constructing a said query to act on said set of superobjects to thereby query information from two or more of said underlying systems.

23. A method as defined in clause 22 further comprising storing said set of superobjects in memory and performing said data processing operation on said stored superobjects.

24. A method as defined in clause 22 wherein said data processing operation is embodied in a data structure, and wherein said constructing comprises defining said data structure.

25. A method as defined in clause 22 wherein said data processing operation is embodied in a data structure, and wherein said constructing comprises defining said data structure.

26. A method as defined in clause 25 wherein said data structure comprises one or more markup language documents, or XML documents.

27. A method as defined in clause 22 wherein a said common interface comprises a markup language, or XML, schema.

28. A method as defined in clause 22 wherein a said superobject comprises a service superobject, wherein said aggrevated services comprise web services, and wherein said common interface is configured as a web service resource.

29. A method as defined in clause 22 wherein said superobjects include at least a data read superobject, a process superobject, and a data output superobject.

30. A method as defined in clause 29 wherein said data output superobject is configured to write data back to one or more of said underlying systems.

31. A method as defined in clause 30 wherein substantially the same data and/or service is provided by two or more of said existing systems; and wherein a said superobject is configured to translate to a common representation for said data and/or service.

32. A method as defined in clause 31 wherein said common representation comprises a selection of said data and/or service from one of said existing systems.

33. A method as defined in clause 31 wherein a said superobject is configured to update substantially the same data and/or service in two or more of said existing systems for a data write operation.

34. A method as defined in clause 22 wherein said set of superobjects is stored in a data store, the method omitting said superobject set constructing.

35. A method as defined in clause 22 further comprising performing said data processing operation.

36. A carrier carrying computer program code to, when running, implementing the method of clause 22.

37. A data processing system including the computer program code carrier of clause 36.

38. A computer system for constructing a data processing operation, the computer system comprising:
data memory operable to store a data structure corresponding to said data processing operation:
program memory storing computer program code; and
a processor coupled to said data memory and to said program memory to load and implement said code comprising code to, when running:
construct a set of superobjects, a said superobject comprising an aggregation of data and/or services made available by said underlying systems and providing a common interface to said systems;
assemble a plurality of said superobjects to define a workflow for said data processing operation, said workflow compriding a group of linked superobjects defining a processing sequence for the superobjects of said group to thereby define said data structure; and/or construct a query to act on said set of superobjects to thereby query information from two or more of said underlying systems.

39. A data structure defining a computer data processing object, the object having:
a plurality of first interfaces, each said first interface comprising a first markup language schema for interfacing to an existing data storage and/or processing system; and
a second interface for providing a common interface to said existing data processing systems.

40. A data structure as defined in clause 39 wherein said second interface comprises a second markup language schema, and further comprising data processing code to translate data and/or services from a first markup language schema of said first interface to a second markup language schema of said second interface.

41. A data structure as defined in clause 40 wherein said first and second markup languages each comprise XML.

42. A data structure as defined in clause 39 wherein said first interface comprise interfaces to a plurality of web services, and wherein said second interface is configured as a web service to provide a single, unified web service interface to said plurality of web services.

43. A data structure as defined in clause 39 wherein two or more of said first interfaces share a common data item and/or service in different formats; and wherein said data structure is configured to map said common data item and/or service to a single data item and/or service at said second interface.

44. A method of providing a unified interface to a plurality of existing data storage and/or processing systems, the method comprising:
interfacing to said plurality of existing storage and/or processing systems using a corresponding plurality of first markup language interfaces; and
translating data and/or services made available by said plurality of existing systems to a single, common second interface using a second markup language.

45. A method of providing a unified interface as defined in clause 44 wherein said first and second markup languages each comprise XML, whereby said second interface comprises an XML interface; and wherein said data and/or services are made available as web services.

46. Data processing code on a carrier, to implement the method of clause 44.

47. A business application development platform having a graphical user interface (GUI), said interface comprising:
a viewing module configured to allow a user to view a set of operations available on a plurality of existing computer systems:
a business application development module configured to allow said user to graphically select and place said operations into said business application; and
an output module to output said business application as one or more markup language documents.

48. A business application development platform as defined in clause 47 wherein said application development module is configured to display a plurality of icons corresponding to operations of said set of operations, and in which at least one said icon has a plurality of links for connecting said icon to other icons, each link corresponding to a state of an operation associated with the icon after execution of the operation.

49. A business application development platform as defined in clause 47 wherein said markup language comprises XML.

50. A business application development platform as defined in defined in clause 47 further comprising a translation module configured to create a translation template for translating between data and/or a service provided by one of said existing computer systems and an internal interface schema used by said business application for interconnecting said operations.

51. A business application development platform as defined in clause 50 wherein two or more of said existing computer systems provide substantially the same data and/or service in different formats; and wherein said translation module is configured for resolving said same data and/or service of said two or more systems to a single common format.

52. A business application development platform as defined in clause 51 wherein said single common format comprises an XML schema.

53. A business application development platform as defined in clause 47 wherein said business application development module is configured to define a plurality of data transfer gateways between said existing computer systems.

54. A data carrier carrying code to implement the business application development platform of clause 47.

55. A computer system storing the code of clause 54.

56. A carrier carrying data defining a data processing operation embodied by the method of clause 1.

57. A carrier as defined in clause 56 wherein said data processing operation is configured to automatically retrieve information from a plurality of Internet sites to create a said superobject.

58. A computer system storing the code of clause 22

59. A carrier as defined in clause 58 wherein said data processing operation is configured to automatically retrieve information from a plurality of Internet sites to create a said superobject.

60. A data structure defining a data processing operation utilising data and/or services provided by a plurality of existing underlying systems, the data structure comprising:
a set of superobjects, a said superobject comprising an aggregation of data and/or services made available by said underlying systems and providing a common interface to said systems; and
data defining a workflow for said data processing operation, said workflow comprising a group of linked superobjects defining a processing sequence for the superobjects of said group, to thereby define said operation.

61. A data structure defining a data processing operation comprising a query, the data processing operation utilising data and/or services provided by a plurality of existing underlying systems, the data structure comprising:
a set of superobjects, a said superobject comprising an aggregation of data and/or services made available by said underlying systems and providing a common inderface to said systems; and
data defining a said query to act on said set of superobjects to thereby query information from two or more of said underlying systems.

62. A data structure as defined in clause 61 wherein said data processing operation includes: retrieval of information from the Internet; and searching said retrived information according to at least one user-defined criteria.

63. A carrier carrying the data structure of clause 60.

64. A carrier carrying the data structure of clause 61.

65. A method of opportunistic monitoring of information on the Internet, the method comprising:
scheduling a data processing operation for automatic implementation; and
running said data processing operation to retrieve and monitor information on the Internet.

66. A method as defined in clause 65 wherein said data processing operation comprises a set of superobjects, a said superobject comprising an aggregation of data and/or services made available by one or more Internet-accessible systems and providing a common interface to said systems, said set of superobjects defining a workflow said workflow comprising a group of linked superobjects defining a processing sequence for the superobjects of said group.

67. A method as defined in clause 65 wherein said automatic implementation is scheduled at user-controllable intervals.

No doubt many other effective alternatives will occur to the skilled person. It will be understood that the invention is not limited to the described embodiments and encompasses modifications apparent to those skilled in the art lying within the spirit and scope of the claims appended hereto.

1. A method of constructing a data processing operation, the data processing operation utilising data and/or services provided by a plurality of existing underlying systems, the method comprising:
constructing a set of superobjects, a said superobject comprising an aggregation of data and/or services made available by said underlying systems and providing a common interface to said systems; and
assembling a plurality of said superobjects to define a workflow for said data processing operation, said workflow comprising a group of linked superobjects defining a processing sequence for the superobjects of said group, to thereby construct said operation.

2. A method as claimed in claim 1 wherein at least one said superobject has a plurality of states, and associated state identification data, and wherein said assembling comprises creating a plurality of links between said at least one said superobject and one or more other superobjects, one link for each said state, or creating a selected link between said at least one said superobject and one or more other superobjects for a selected said state.

3. A method as claimed in claim 2 wherein said state identification data is formatted as an XML data subtype having a plurality of switches to identify said plurality of states.

4. A method as claimed in claim 1 wherein said assembling includes providing a graphical user interface for a user to select said superobjects and define said workflow.

5. A method as claimed in claim 2 wherein said assembling includes providing a graphical user interface for a user to select said superobjects and define said workflow; and wherein said graphical user interface is configured to provide graphical icons for said superobjects, an icon for said at least one superobject with a plurality of states having a plurality of links, one for each said state.

6. A method as claimed in claim 1 wherein said workflow includes reading data from one or more of said underlying systems, operating on said data using services of a plurality of said underlying systems defined by means of a single said superobject, and outputting a result.

7. A method as claimed in claim 1 further comprising storing said set of superobjects in memory and performing said data processing operation on said stored superobjects.

8. A method of constructing a data processing operation comprising a query, the data processing operation utilising data and/or services provided by a plurality of existing underlying systems, the method comprising:
constructing a set of superobjects, a said superobject comprising an aggregation of data and/or services made available by said underlying systems and providing a common interface to said systems; and
constructing a said query to act on said set of superobjects to thereby query information from two or more of said underlying systems.

9. A method as claimed in claim 8 further comprising storing said set of superobjects in memory and performing said data processing operation on said stored superobjects.

10. A method as claimed in claim 8 wherein said data processing operation is embodied in a data structure, and wherein said constructing comprises defining said data structure.

11. A method as claimed in claim 8 wherein said data processing operation is embodied in a data structure, and wherein said constructing comprises defining said data structure.

12. A method as claimed in claim 11 wherein said data structure comprises one or more markup language documents, or XML documents.

13. A method as claimed in claim 8 wherein a said common interface comprises a markup language, or XML, schema.

14. A method as claimed in claim 8 wherein a said superobject comprises a service superobject, wherein said aggregated services comprise web services, and wherein said common interface is configured as a web service resource.

15. A method as claimed in claim 8 wherein said superobjects include at least a data read superobject, a process superobject, and a data output superobject.

16. A business application development platform having a graphical user interface (GUI), said interface comprising:
a viewing module configured to allow a user to view a set of operations available on a plurality of existing computer systems:
a business application development module configured to allow said user to graphically select and place said operations into said business application; and
an output module to output said business application as one or more markup language documents.

17. A business application development platform as claimed in claim 16 wherein said application development module is configured to display a plurality of icons corresponding to operations of said set of operations, and in which at least one said icon has a plurality of links for connecting said icon to other icons, each link corresponding to a state of an operation associated with the icon after execution of the operation.

18. A business application development platform as claimed in claim 16 wherein said markup language comprises XML.

19. A business application development platform as claimed in claimed in claim 16 further comprising a translation module configured to create a translation template for translating between data and/or a service provided by one of said existing computer systems and an internal interface schema used by said business application for interconnecting said operations.

20. A business application development platform as claimed in claim 19 wherein two or more of said existing computer systems provide substantially the same data and/or service in different formats; and wherein said translation module is configured for resolving said same data and/or service of said two or more systems to a single common format.
